(19) United States
(12) Patent Application Publication
(10) Pub. No.: US 2025/0208796 A1
(43) Pub. Date: Jun. 26, 2025

(54) IMAGE INSPECTION APPARATUS, IMAGE INSPECTION METHOD, AND COMPUTER-READABLE RECORDING MEDIUM STORING IMAGE INSPECTION PROGRAM

(71) Applicant: KONICA MINOLTA, INC., Tokyo (JP)

(72) Inventor: Yoshihiro ESUMI, Tokyo (JP)

(21) Appl. No.: 18/934,367

(22) Filed: Nov. 1, 2024

(30) Foreign Application Priority Data
Dec. 21, 2023 (JP) 2023-215831

(51) Int. Cl. G06F 3/12; G06T 7/00

(52) U.S. Cl. CPC G06F 3/1208; G06F 3/1256; G06T 7/001; G06F 3/126; G06T 2207/30144; G06T 2207/30176

(57) ABSTRACT

This image inspection apparatus includes a hardware processor that, generates a reference image to be used for inspection of an image formed on a recording medium; inspects the image formed on the recording medium based on the reference image; and receives designation of a generation timing of generating the reference image.

### CROSS-REFERENCE TO RELATED APPLICATION

The present invention claims priority under 35 U.S.C. § 119 to Japanese patent application No. 2023-215831, filed on Dec. 21, 2023, the entire content of which is incorporated herein by reference.

### BACKGROUND OF THE INVENTION

### 1. Technical Field

The present invention relates to an image inspection apparatus, an image inspection method, and a computer-readable recording medium storing an image inspection program.

### 2. Description of Related art

Conventionally, the quality of a printed product is inspected by comparing a reference image registered in advance with an inspection image obtained by reading the printed product to be inspected. For example, in Japanese Unexamined Patent Publication No. 2019-132966, image data derived from an original image used for printing is used as a reference image in a proof mode for confirming the finished quality. Then, subsequent main printing uses read image data obtained by reading the printed product that has been visually confirmed by the user to have no abnormality in the proof mode.

### SUMMARY OF THE INVENTION

In the technique disclosed in Japanese Unexamined Patent Publication No. 2019-132966, processing performed by a user up to the generation of a reference image used for main printing is complicated, and the user needs to execute main printing after the reference image is prepared in advance.

The present invention has been made in view of the above-described circumstances, and an object of the present invention is to provide an image inspection apparatus, an image inspection method, and a computer-readable recording medium storing an image inspection program with which it is possible to further shorten the time required for processing from generation of a reference image to image inspection as compared with the conventional technology.

To achieve at least one of the abovementioned objects, according to an aspect of the present invention, a device reflecting one aspect of the present inventions comprises the followings.

An image inspection apparatus including a hardware processor that,
generates a reference image to be used for inspection of an image formed on a recording medium;
inspects the image formed on the recording medium based on the reference image; and
receives designation of a generation timing of generating the reference image.

### BRIEF DESCRIPTION OF THE DRAWINGS

The advantages and features provided by one or more embodiments of the present invention will be more fully understood from the following detailed description and the accompanying drawings. However, these are for purposes of illustration only and are not intended to limit the present invention.

FIG. 1 is a diagram illustrating a schematic configuration of a printing system including an image inspection apparatus according to a first embodiment.

FIG. 2 is a block diagram illustrating a hardware configuration of the image inspection apparatus.

FIG. 3 is a schematic diagram for describing image inspection processing.

FIG. 4 is a schematic diagram illustrating a flow of each data.

FIG. 5 is a schematic diagram illustrating, in a time-series manner, processing of acquiring a document image, processing of generating a reference image, processing of forming an inspection image, and processing of inspecting the inspection image when a first timing is designated.

FIG. 6A is an example of an operation screen for describing designation of a second timing.

FIG. 6B is an example of an operation screen displayed following the operation screen in FIG. 6A.

FIG. 6C is an example of an operation screen for describing designation of the first timing;

FIG. 6D is an example of an operation screen displayed subsequent to FIG. 6C;

FIG. 6E is an example of an operation screen displayed following the operation screen in FIG. 6D.

FIG. 6F is an example of an operation screen for describing designation of a first timing.

FIG. 6G is an example of an operation screen displayed following the operation screen in FIG. 6F.

FIG. 7 is a flowchart illustrating a processing procedure of an image inspection method.

FIG. 8A is a flowchart illustrating a processing procedure in a first inspection mode performed subsequent to the processing in FIG. 7.

FIG. 8B is a subroutine flowchart illustrating reference image generation completion determining processing.

FIG. 9 is a flowchart illustrating a processing procedure in a second inspection mode performed subsequent to the processing in FIG. 7.

FIG. 10 is a subroutine flowchart illustrating processing for generating a reference image.

FIG. 11 is a subroutine flowchart illustrating image inspection processing.

### DETAILED DESCRIPTION

An embodiment of the present invention will be described below with reference to the accompanying drawings. It is to be noted that the scope of the present invention is not limited to the embodiment to be described. Note that in the description of the drawings, the same components are denoted by the same reference signs, and redundant descriptions will not be repeated. The advantages and features provided by one or more embodiments of the present invention will be more fully understood from the detailed description set forth below and the accompanying drawings. Furthermore, the accompanying drawings are provided for illustration only and are not intended to define the scope of the present invention.

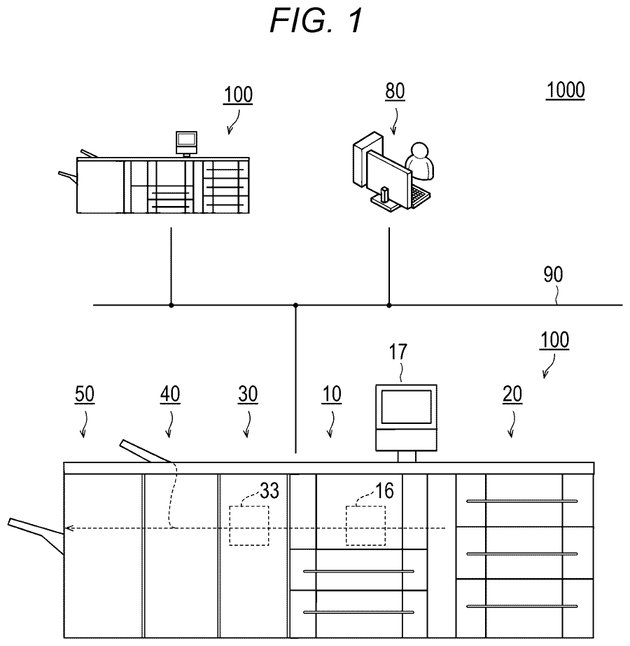

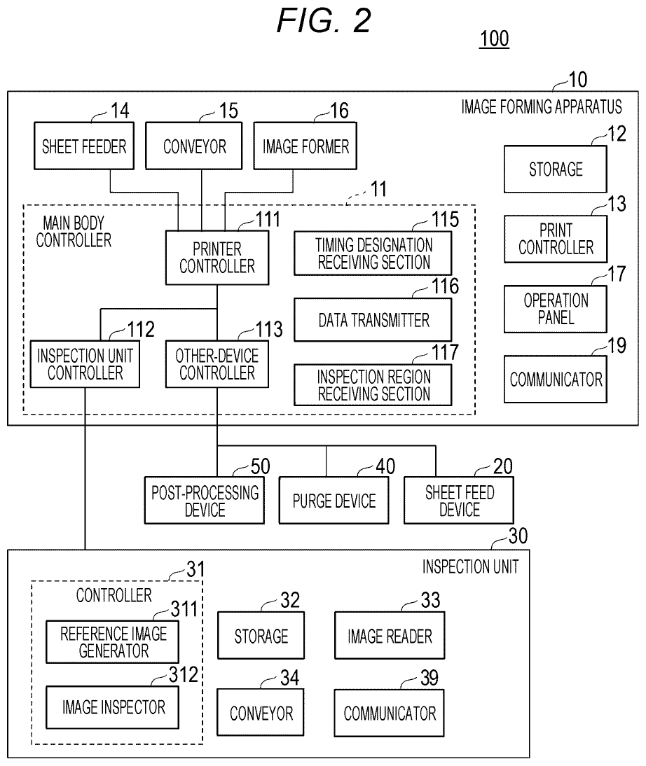

FIG. 1 is a diagram illustrating a schematic configuration of an image inspection apparatus 100 and a printing system 1000 including the image inspection apparatus 100 according to a first embodiment. FIG. 2 is a block diagram illustrating a hardware configuration of the image inspection apparatus 100. As illustrated in FIG. 1, the printing system 1000 includes a terminal device 80 and one or more image inspection apparatuses 100, those of which are communicatively connected via a network 90.

The terminal device 80 may be, for example, a personal computer, a tablet terminal, a smartphone, or the like. A printer driver for converting document data into a print job is installed in the terminal device 80. The terminal device 80 is used by a user such as an operator who operates the image inspection apparatus 100. The printer driver generates, in response to a user's instruction, a print job in a format compatible with a print controller 13 (see FIG. 2 described later) of the image inspection apparatus 100. Then, the print job is transmitted to the image inspection apparatus 100 via the network 90. In addition, the terminal device 80 includes a display, and can display an inspection result (non-defective/defective) of a printed product, an image of a defective printed product, and the like.

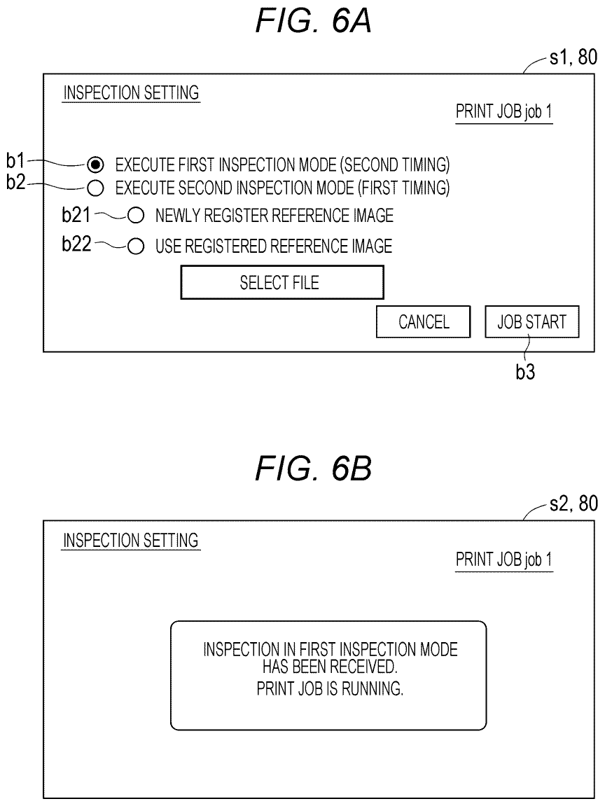

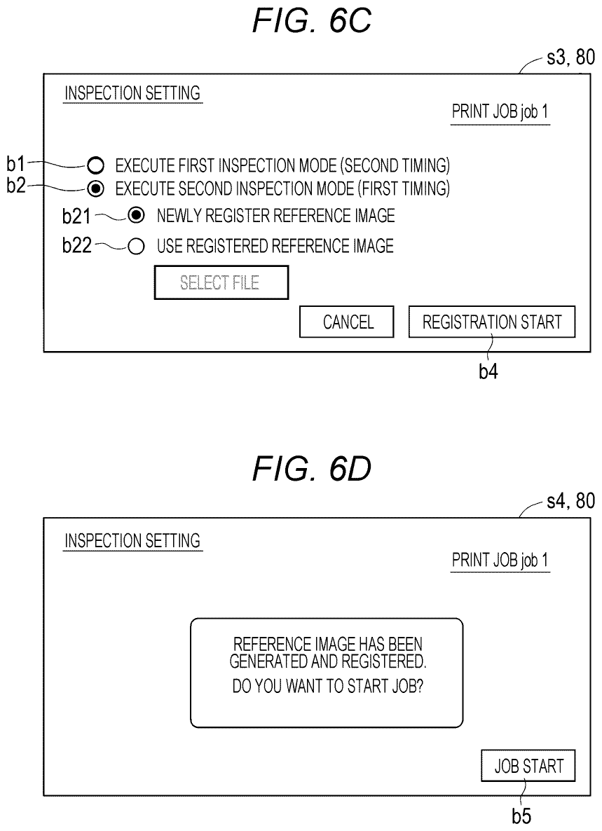

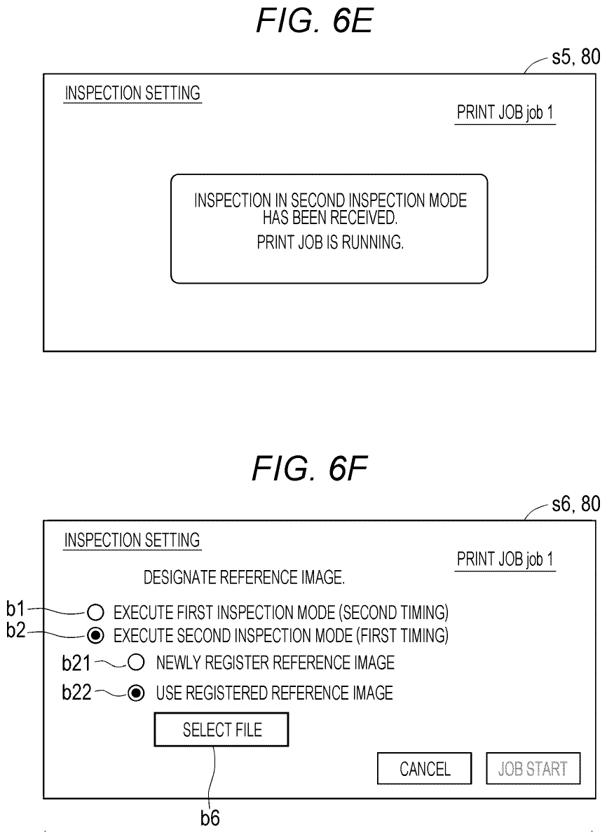

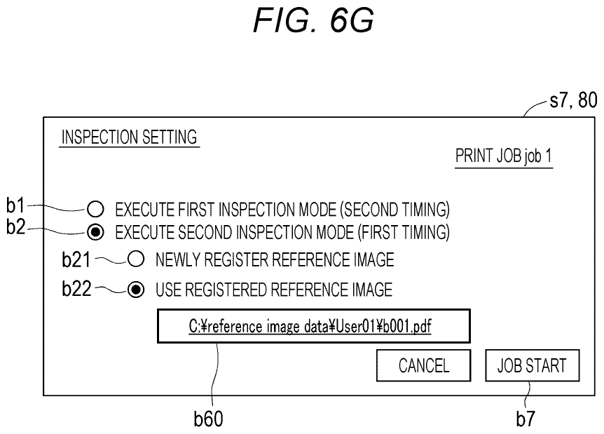

The print job includes, for example, print data in a page description language (PDL) format (hereinafter, also referred to as document image data or a document image) and job setting information (hereinafter, referred to as job setting). The document image includes, for example, document images of first to n-th pages. The job setting includes a print setting such as the number of pages, the number of copies, the type, size, and basis weight of a sheet (recording medium), and single-sided printing/double-sided printing. The job setting also includes an inspection condition. The inspection condition includes whether to perform image inspection (inspection setting ON/OFF), and which mode is selected from first and second inspection modes when the image inspection is “ON”. The inspection condition may also include inspection region designation information (described later). Furthermore, when the second inspection mode is selected, the inspection condition includes path information (file directory information) for designating a file of a registered reference image to be used. The user can issue an image inspection instruction to the printing system 1000 by setting the inspection ON (by turning on the inspection setting). The inspection condition can be set through an operation screen (e.g., FIG. 6A described later) displayed by the printer driver.

### Image Inspection Apparatus 100

The image inspection apparatus 100 is also referred to as an image forming system. The image inspection apparatus 100 includes an image forming apparatus 10, a sheet feed device 20, an inspection unit 30, a purge device 40, and a post-processing device 50 that are mechanically and electrically connected to each other.

### Outline of Inspection Unit 30

The inspection unit 30 which will be described in detail later includes a reference image generator 311 that generates a reference image used for inspection of an image formed on a recording medium (sheet). The reference image generator 311 generates a reference image based on the document image. The inspection unit 30 further includes an image inspector 312 that inspects the image formed on the sheet on the basis of the reference image. The image forming apparatus 10 (image former 16) forms an image on a sheet based on a document image. The image inspector 312 inspects the image on a sheet by comparing an inspection image obtained by reading the image on the sheet based on a document image with a reference image generated based on the same document image.

### Image Forming Apparatus 10

The image forming apparatus 10 forms an image on a sheet that has been fed and conveyed from the sheet feed device 20 on the upstream side. Further, the image forming apparatus 10 forms an image on a sheet fed from a sheet feeder of the image forming apparatus 10.

As illustrated in FIG. 2, the image forming apparatus 10 includes a main body controller 11, a storage 12, a print controller 13, a sheet feeder 14, a conveyor 15, an image former 16, an operation panel 17, and a communicator 19. These constituent elements are connected to each other via a signal line such as a bus for exchanging signals. Note that in FIG. 2, connection signal lines to some constituent elements such as the storage 12 and the print controller 13 in the image forming apparatus 10 are not illustrated. Similarly, in the inspection unit 30, connection lines between some of the constituent elements are not illustrated.

### Main Body Controller 11

The main body controller 11, which includes a CPU, a ROM, a RAM, and the like, executes various kinds of processing by executing programs stored in the ROM and the storage 12 described later, and performs control of each section of the apparatus and various kinds of arithmetic processing in accordance with the programs. The main body controller 11 functions as a printer controller 111, an inspection unit controller 112, an other-device controller 113, a timing designation receiving section 115, a data transmitter 116, and an inspection region receiving section 117. Details of each sub-function will be described later. The main body controller 11 cooperates with the controller 31 and the like of the inspection unit 30 to control the entire image inspection apparatus 100.

### Storage 12

The storage 12 includes an auxiliary storage such as a hard disk that stores various kinds of programs and various kinds of data in advance. The storage 12 also functions as a page memory (the same applies to a storage 32 described later).

### Print Controller 13

The print controller 13 analyzes the print job received from the terminal device 80 via the network 90, performs processing such as color conversion, screening, and rasterization, and generates a document image in a bitmap format. The generated document image is transmitted to the controller 31. The print controller 13 functions as a document image acquirer.

The print controller 13 receives a print job from the terminal device 80 or the like via the communicator 19. The received print job includes print data (mainly in a PDL format) serving as a source of a document image (also referred to as document image data) and job information in which a print setting such as the type of a sheet to be used is described. The print controller 13 performs rasterization (RIP) processing for converting print data into bitmap data in units of pages based on the print setting. The RIP image after the rasterization processing is temporarily stored in an image memory inside the print controller 13. The RIP image on the image memory is temporarily stored in a compression memory region of a page memory of the storage 12. At the time of normal printing, the RIP image stored in the compression memory region is decompressed by a compression/decompression IC and is transmitted to the image former 16 as a document image via the writing processor, and printing is executed.

### Sheet Feeder 14, Conveyor 15

The sheet feeder 14 includes a plurality of sheet feed trays. The conveyor 15 includes a conveyance path. The conveyance path includes a plurality of conveyance roller pairs provided along the conveyance path and a drive motor (not illustrated) that drives the conveyance roller pairs. The sheet feeder 14 includes a delivery roller that delivers an uppermost sheet of a plurality of sheets loaded and placed in the sheet feed tray and delivers the sheets in the sheet feed tray to the conveyance path on the downstream side one by one.

### Image Former 16

The image former 16 forms an image with, for example, an electrophotographic method. The image former 16 includes writing sections (laser exposure sections) and photosensitive drums respectively corresponding to basic colors of yellow (Y), magenta (M), cyan (C), and black (K), and developing devices each accommodating a two-component developer including toner of the corresponding color and a carrier. The image former 16 further includes an intermediate transfer belt, a secondary transferer, and a fixer. The toner images formed on the photosensitive drums by the developing devices of the respective colors are superimposed on the intermediate transfer belt and are transferred onto the conveyed sheet in the secondary transferer. The toner image on the sheet is fixed on the sheet by being heated and pressed by the fixer on a downstream side.

### Operation Panel 17

The operation panel 17 includes a touch screen, a numeric keypad, a start button, a stop button, and the like. The operation panel 17 displays a state of the image forming apparatus 10 or the image inspection apparatus 100 and is used to input various settings and instructions from the user. The operation panel 17 also displays an inspection result by the inspection unit 30 and receives setting of the inspection condition and input of an execution instruction.

### Communicator 19

The communicator 19 is an interface for communicating with devices on the network such as a PC or other devices 20, 30, or the like.

### Sub-Functions 111 to 117

### Printer Controller 111

When receiving a print job, the printer controller 111 executes the print job on the basis of print job setting information (hereinafter referred to as job setting) of the input print job. The print job is input in response to an instruction sent from the operation panel 17 or the terminal device 80 such as a network-connected PC operated by the user. The job setting also includes a print setting and an inspection condition. The print setting includes double-sided/single-sided printing, the type of printing sheet, post-processing conditions, and the like. The inspection condition which will be described in detail later is set, for example, on an operation screen illustrated in FIG. 6A or the like to be described later.

The printer controller 111 controls the feeding and conveyance of a sheet by controlling the sheet feeder 14 and the conveyor 15. The printer controller 111 also causes the image former 16 to form an image on a sheet under the set image forming condition by controlling the image former 16.

The inspection unit controller 112 controls the inspection unit 30 in response to an execution instruction request (inspection instruction) from the printer controller 111.

The other-device controller 113 controls the sheet feed device 20, the purge device 40, and the post-processing device 50. Specifically, the other-device controller 113 communicates with the sheet feed device 20 to transmit and receive a sheet feed tray to be used, a sheet conveyance timing, and the like. The other-device controller 113 transmits to the purge device 40, a sheet conveyance timing, designation of a main conveyance path or a sub conveyance path for the sheet to be conveyed, information regarding setting of post-processing for the post-processing device 50, and the like.

### Timing Designation Receiving Section 115

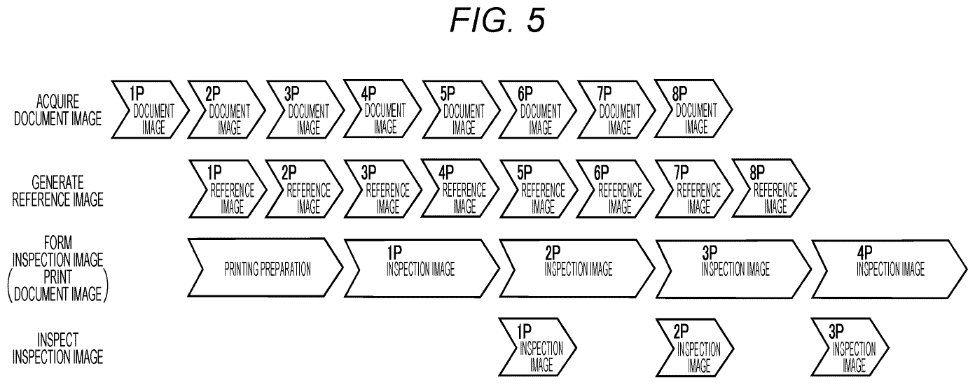

The timing designation receiving section 115 receives designation of a generation timing of generating a reference image. Based on the received generation timing, the main body controller 11 controls the generation or the generation timing of the reference image by the reference image generator 311. The generation timing includes a first timing and a second timing different from the first timing. The first timing is a timing before image formation by the image forming apparatus 10 (or the image former 16). The second timing is, for example, a timing during image formation. More specifically, when images are formed and reference images are generated based on document images of a plurality of pages, the generation of the reference image is started during the image formation. The term “during image formation” refers to a period from when a sheet on which an image of the first page of the document image including a plurality of pages is to be formed is started to be fed by the sheet feeder 14 to when the formation of an image of the last page on a sheet by the image former 16 is completed and the sheet completely passes through the image former 16. An example of the first timing will be described later (FIG. 5).

### First Inspection Mode, Second Inspection Mode

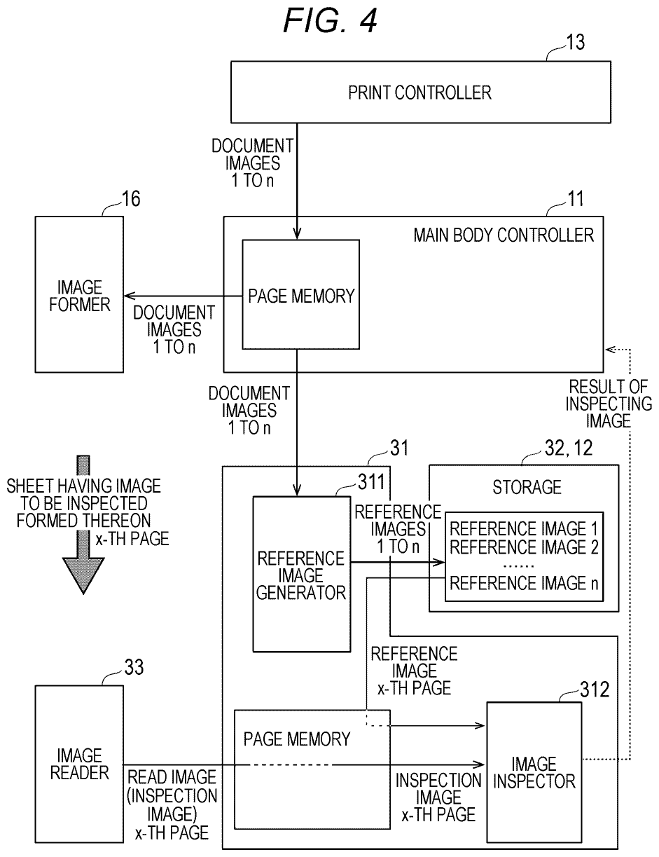

In the embodiment described below, the image inspection in which the generation timing of generating the reference image is the first timing corresponds to the second inspection mode. The image inspection in which the generation timing of generating the reference image is the second timing corresponds to the first inspection mode. An example of receiving the first or second inspection mode will be described later (FIG. 4A, etc.).

It can also be said that the execution instruction to execute inspection can be received before the generation of the reference image is completed in the first inspection mode. In the first inspection mode, in parallel with processing of forming the image for inspection on the sheet by the image former 16 based on the document image, the reference image generation processing by the reference image generator 311 is executed based on the same document image.

It can also be said that the instruction to execute inspection can be received after the generation of the reference image is completed in the second inspection mode. In the second inspection mode, the reference image generation processing by the reference image generator 311 is executed on the basis of the document image, and thereafter, an execution instruction to execute inspection using the generated reference image is received. Thus, the inspection is executed. Alternatively, inspection using the reference image that has already been registered is performed in the second inspection mode. The latter includes both a case where a reference image is newly generated and registered for inspection and a case where a registered reference image is reused.

### Data Transmitter 116

The data transmitter 116 transmits the document image to the image former 16 and the inspection unit 30 (particularly, the reference image generator 311). In particular, the data transmitter 116 transmits the document image to the image former 16 and the inspection unit 30 (in particular, the reference image generator 311) in response to the reception of the execution of inspection in the first inspection mode. For example, in response to the reception of execution of inspection in the first inspection mode, the data transmitter 116 immediately transmits the document image to both the image former 16 and the reference image generator 311 at the same time. Further, the data transmitter 116 transmits the document image to the image former 16 in response to the reception of the execution of inspection in the first inspection mode. In addition, the data transmitter 116 transmits the document image to the image former 16 in response to the reception of execution of inspection in the second inspection mode by the second reception section.

### Inspection Region Receiving Section 117

The inspection region receiving section 117 receives (a) designation of an inspection exclusion region and (b) designation of an inspection region (hereinafter, these are collectively referred to as “inspection region designation information”). Further, the inspection region receiving section 117 transmits the received inspection region designation information to the reference image generator 311. The inspection region designation information is described with a target region range (XY coordinate positions along the main scanning direction (X direction) and the sub-scanning direction (Y direction)) and its content. The region range is rectangular, for example. The region designated as the inspection exclusion region (a) is not an object to be inspected. The region designated as the inspection region (b) is a region to be inspected. It is also possible to perform inspection different from normal inspection in the region designated as the inspection region. For example, in a document image including an image of a human face, the color inspection level is strictly set in a region including the skin of the face. In addition, the designation of the inspection region includes designation of a barcode. A barcode (that is one dimensional or two dimensional) may be included in a document image, and in this case, in an inspection region in which the barcode is designated, an image in the inspection region is decoded to inspect whether or not printing of the barcode is correct.

### Sheet Feed Device 20

The sheet feed device 20 illustrated in FIG. 1 and FIG. 2 includes a sheet feeder and a conveyor similar to those of the image forming apparatus 10. In addition, the sheet feed device 20 includes a controller, a storage, and a communicator (none of which are illustrated) in addition to the conveyor and the sheet feeder, and these components are connected to each other via a signal line such as a bus for exchanging signals.

### Inspection Unit 30

Next, the inspection unit 30 will be described. As illustrated in FIG. 2, the inspection unit 30 includes a controller 31, a storage 32, an image reader 33, a conveyor 34, a communicator 39, and the like. The controller 31, the storage 32, the conveyor 34, and the communicator 39 have the same hardware configuration as the main body controller 11, the storage 12, the conveyor 15, and the communicator 19, respectively, of the image forming apparatus 10 described above, and thus the description thereof will be omitted.

The image reader 33 reads a sheet (printed product) conveyed through the conveyance path with, for example, a charge coupled device (CCD) image sensor. The controller 31 controls the scanner so that the scanner reads an image (inspection image) formed on the sheet conveyed from the image forming apparatus 10 according to a reading instruction from the inspection unit controller 112. The controller 31 also performs various kinds of processing such as analog processing, A/D conversion processing, and shading processing on an analog image signal output from the image reader 33 and generates digital image (read image) data.

### Controller 31

The controller 31 functions as the reference image generator 311 and the image inspector 312.

The reference image generator 311 generates a reference image by performing the following various kinds of processing on the basis of a document image acquired by the image forming apparatus 10 (particularly, the print controller 13).

The reference image generator 311 and the image inspector 312 may be configured by independent CPUs so that the reference image generation processing and the image inspection processing can be performed in parallel. That is, the controller 31 includes a plurality of CPUs. Alternatively, a multicore CPU is applied as the CPU of the controller 31. When a multicore CPU is applied, the reference image generator 311 is assigned to a core different from the core for the processing of forming and inspecting the inspection image by the image inspector 312. Then, the generation of the reference image and the formation and inspection of the inspection image can be executed in parallel by different cores.

### Reference Image Generator 311

The reference image generator 311 generates a reference image by performing various kinds of processing on the document image in terms of position, resolution, color, and the like. For example, in order that content portions (contents) of the reference image and the read image (inspection image) can be compared with each other, the reference image generator 311 can extract the position information of the content portion from the document image. Then, the reference image generator 311 can add or embed the position information to or in the reference image. That is, the reference image generated by the reference image generator 311 includes alignment information (also referred to as a feature amount for alignment) for aligning the reference image and the inspection image when the image inspection is performed based on the reference image. Note that the alignment information includes outline information and edge information of the image. The reference image generated by the reference image generator 311 has region information regarding inspection regions and inspection exclusion regions on the basis of the inspection region designation information received by the inspection region receiving section 117 described above. In addition, the reference image generator 311 can generate a reference image by adjusting the resolution of the document image so as to match the resolution of the image reader 33 (scanner). Furthermore, the reference image generator 311 can generate a reference image by converting the color space of the document image data so as to match the color space (e.g., RGB) adopted by the image reader 33.

The reason why the reference image generator 311 does not use the document image as it is as follows. Ideally, the read image (inspection image) generated by reading the image formed on the sheet is considered to match the document image in terms of content. However, when the inspection image formed on the sheet is read by the scanner, an error may occur in the inspection image with respect to the document image due to various factors such as variations in a conveyance path for the sheet, a reading position shift by the scanner, color reproducibility, and a difference in paper type. An error may also occur in the document image depending on the resolution of reading by the scanner. Therefore, when the inspection image and the document image are simply compared, an error is highly likely to occur, and it is not realistic to inspect the inspection image by simply comparing the inspection image with the document image. In view of this, in the present embodiment, the reference image generator 311 is configured to generate a reference image by performing various kinds of processing on the document image in terms of position, resolution, color, and the like so that the reference image can be compared with the inspection image, and to compare the reference image and the inspection image. Thus, the reference image can be appropriately compared with the inspection image, whereby the printed product can be accurately inspected.

### Image Inspector 312

The image inspector 312 performs image inspection based on a reference image. More specifically, the image inspector 312 acquires the reference image and the read image and compares the reference image with the read image page by page to inspect the inspection image formed on the sheet.

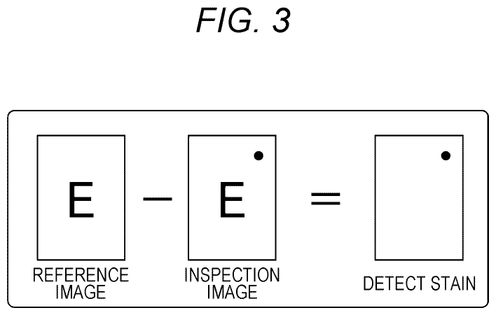

FIG. 3 is a schematic diagram for describing image inspection processing. The image inspector 312 calculates a difference (error) in pixel value between the reference image and the read image for each page and determines the quality of the inspection image according to the magnitude of the difference. The difference can be calculated for each page, each object, or each region. For example, in a case where the difference is calculated for each page, an inspection result indicating “non-defective” is output when the total value of the differences of the pixels in one page is less than a specified value, and an inspection result of “defective” is output when the total value of the differences is equal to or more than the specified value. In addition, when the difference is calculated for each object or for each region, an inspection result indicating “non-defective” or “defective” is output according to the total value of differences between pixel values in the selected object or region.

When the result of inspecting the inspection image indicates “non-defective”, the controller 31 determines that the printed product is a non-defective product. When the result of inspecting the inspection image indicates “defective”, the controller 31 determines that the printed product is a defective product. The determination result is sent to the main body controller 11.

### Purge Device 40

The purge device 40 is provided with a branch portion of the conveyance path and is provided with a main conveyance path leading to the post-processing device 50 and a sub conveyance path leading to a purge tray (disposed above the purge device 40 in FIG. 1). For example, a sheet determined to be defective in quality in the inspection by the inspection unit 30 is ejected to the purge tray.

### Post-Processing Device 50

The post-processing device 50 performs post-processing on the sheet sent from the image forming apparatus 10 on the upstream side or ejects the sheet according to the setting of the print job. The post-processing device 50 includes a sheet ejection tray, a post-processor, and a conveyance path. In addition, the post-processing device 50 includes a controller, a storage, a conveyor, and a communicator (none of which are illustrated), and these components are connected to each other via a signal line such as a bus for exchanging signals. The post-processor performs at least one of stapling, punching, cutting, folding, or bookbinding on the sheet on which an image has been formed.

### Flow of Each Data in Image Inspection Apparatus 100

FIG. 4 is a schematic diagram illustrating the flow of data in the processing of image formation and image inspection by the image inspection apparatus 100 illustrated in FIG. 2.

The main body controller 11 acquires a job setting (not illustrated) and a document image from the print controller 13. The document image is a RIP image obtained by rasterizing print data. The document image is stored in a page memory. The job setting includes information such as an inspection condition and a print setting. The inspection condition includes whether to perform image inspection, and which mode is selected from first and second inspection modes when the image inspection is “ON”. Furthermore, when the second inspection mode is selected, the inspection condition includes path information (file directory information) for designating a file of a registered reference image to be used. The example in FIG. 4 will be described assuming that the first inspection mode is mainly selected as the job setting. The example in FIG. 4 will also be described assuming that the document image includes n pieces of print data from pages 1 to n.

In the first inspection mode, the main body controller 11 (the data transmitter 116) transmits the document image stored in the page memory to both the image former 16 and the reference image generator 311 at the same time.

The reference image generator 311 sequentially generates reference images 1 to n of pages 1 to n from the received document images (pages 1 to n) and stores the reference images 1 to n in the storage 32.

In FIG. 4, x is a value incrementing to the n-th page from 1 that is the initial value. The image former 16 forms images on the sheets in order from the first to n-th pages. x indicates the current page value.

The image reader 33 generates a read image by reading a conveyed sheet (x page). The read image obtained by reading is sent to the image inspector 312 as an inspection image of the x-th page via the page memory. The reference image x corresponding to the x-th page is sent from the storage 32 to the image inspector 312 via the page memory.

The image inspector 312 inspects the inspection image by comparing the acquired reference image with the inspection image. Then, the controller 31 (image inspector 312) outputs the result of inspecting the inspection image to the main body controller 11. Note that, although FIG. 3 illustrates an example in which the reference image generated by the reference image generator 311 is stored in the storage 32, the reference image may be stored in the storage 12 of the image forming apparatus 10. In addition, the main body controller 11 and the controller 31 which are illustrated as separate components in FIGS. 2, FIG. 4, etc. may be integrated. That is, the controller 31 may be integrated into the main body controller 11.

Here, when the timing designation receiving section 115 receives the execution of inspection in the first inspection mode, the generation of the reference image by the reference image generator 311 and the formation of the image (inspection image) by the image former 16 are executed in parallel. FIG. 5 is a schematic diagram illustrating, in a time-series manner, processing of acquiring a document image, processing of generating a reference image, processing of forming an inspection image, and processing of inspecting the inspection image when the second timing is designated.

FIG. 5 illustrates the following processing in order from the top.
(Processing 1) Acquire document image by main body controller 11
(Processing 2) Generate reference image by reference image generator 311
(Processing 3) Form image to be inspected by image forming apparatus 10 (image former 16)
(Processing 4) Perform inspection using inspection image and reference image by image inspector 312

Furthermore, FIG. 5 illustrates printing and inspection of a total of 8 pages (n=8) of the document image. Note that FIG. 5 does not illustrate processing 3 and processing 4 for the 3P (page) and 4P, and subsequent pages. Note that in FIG. 5, printing preparation is included in a period during image formation. The printing preparation includes feeding a sheet for the first page by the sheet feeding device 20 or the sheet feeder 14 and data processing such as rasterization processing by the image forming apparatus 10.

As illustrated in FIG. 5, the generation of the reference image by the reference image generator 311 and the formation of the inspection image by the image former 16 are performed in parallel. Specifically, the processing of generating the reference images for pages 1 to 8 and the image formation by the image former 16 are executed in parallel.

### Image Inspection Method

The image inspection method according to the present embodiment will be described below with reference to FIGS. 6A to FIG. 11.

First, setting of inspection condition for image inspection in the present embodiment will be described. FIGS. 6A to FIG. 6G are operation screens (operation screens s1 to s7) for setting the inspection condition of the image inspection and issuing an execution instruction. The print setting other than the inspection condition related to the PRINT JOB job 1 and the designation of the document image are performed using another operation screen (not illustrated). The operation screens s1 to s7 are displayed on the terminal device 80 in which the printer driver is installed or the operation panel 17. In the operation screens s1, s3, and the like, the user can select either radio button b1 or b2. When the user selects b2, the user can further select either b21 or b22.

### Second Timing

The designation of the second timing will be described with reference to FIGS. 6A and FIG. 6B. The button b1 (and b3) on the operation screen s1 in FIG. 6A corresponds to the first reception section. In the operation screen s1, the user selects the button b1 and presses the job start button b3. Thus, the timing designation receiving section 115 of the image inspection apparatus 100 receives the execution instruction from the image inspector 312 before the generation of the reference image by the reference image generator 311 is completed (first inspection mode). Upon receipt of the execution instruction, the image inspection apparatus 100 immediately forms an image and inspects the formed image. The operation screen s2 illustrated in FIG. 6B is a screen displayed following the operation screen s1 in FIG. 6A. When the user presses the job start button b3, the timing designation receiving section 115 receives an instruction to execute inspection in the first inspection mode. In response to the reception, the operation screen s2 indicating that the first inspection mode has been received is displayed.

### First Timing

The designation of the first timing (part 1) will be described with reference to FIGS. 6C to FIG. 6E. The button b2 (and b21 and b5 (operation screen s4)) in the operation screen s3 in FIG. 6C corresponds to the designation of the first timing. The user selects the button b2, further selects the button b21, and presses a registration start button b4. Thus, the reference image generator 311 of the image inspection apparatus 100 newly generates a reference image based on the document image and registers the generated reference image in the storage 32 or the like. Upon the registration, the operation screen s4 in FIG. 6D is displayed. The user presses the job start button b5 on the operation screen s4. Thus, the timing designation receiving section 115 of the image inspection apparatus 100 receives the execution instruction to execute inspection from the image inspector 312 after the generation of the reference image by the reference image generator 311 is completed. The operation screen s5 illustrated in FIG. 6E is a screen displayed following the operation screen s4 in FIG. 6D. When the timing designation receiving section 115 receives the instruction to execute inspection in the second inspection mode, the operation screen s5 is displayed.

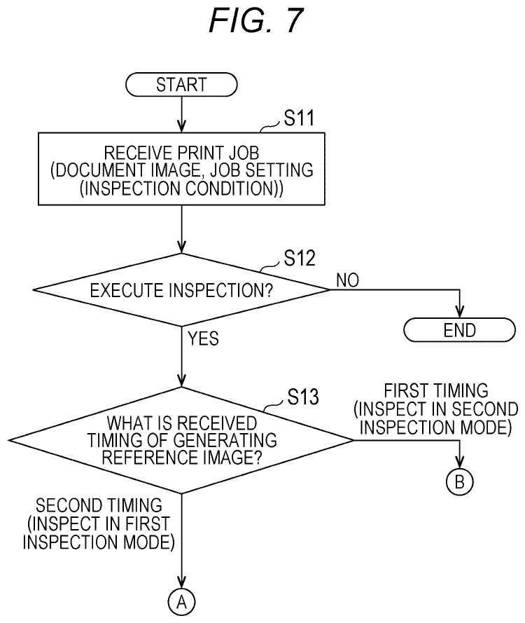

Next, the designation of the first timing (part 2) will be described with reference to FIGS. 6F and FIG. 6G. The buttons b2, b22, and b7 on the operation screen s7 in FIG. 6G correspond to the designation of the first timing. The user selects the buttons b2 and b22 on the operation screen s6 and further presses a selection button bb6. Thus, the user pops up a screen for designating the path of a file (not illustrated) and designates the file of a reference image generated and registered in the past. The file of the reference image is stored in, for example, the storage 32 (or the storage 12). In the operation screen s7 in FIG. 6G, the designated reference image (the path of the reference image) is illustrated in a display field b60. The user presses a job start button b7 on the operation screen s7. Thus, the timing designation receiving section 115 of the image inspection apparatus 100 receives the execution instruction to execute inspection from the image inspector 312 after the generation of the reference image by the reference image generator 311 is completed. When the job start button b7 on the operation screen s7 is pressed, the operation screen s5 indicating that the instruction to execute the inspection in the second inspection mode is received is also displayed. Next, the image inspection according to the setting of the inspection condition of the image inspection and the execution instruction received through the operation screens in FIGS. 6A to FIG. 6G will be described with reference to FIGS. 7 to FIG. 9.

### Image Inspection Method

FIGS. 7 to FIG. 9 are flowcharts illustrating the image inspection method.

### Step S11

The image inspection apparatus 100 receives the print job. The print job includes a job setting such as a document image (print data) and an inspection condition. In the following, an example in which the document image includes image data of a plurality of pages from 1 to n-th pages as in the example in FIG. 4 will be described.

### Step S12

The controller 11 of the image inspection apparatus 100 determines whether or not the execution of inspection is set by referring to the inspection condition described in the job setting. When the inspection is to be performed (YES), the controller 11 advances the processing to step S13, and when the inspection is not to be performed (NO), the controller 11 ends the processing (END). In this case, normal image formation in which the image inspection is not performed is performed for the print job, and the description thereof will be omitted.

### Step S13

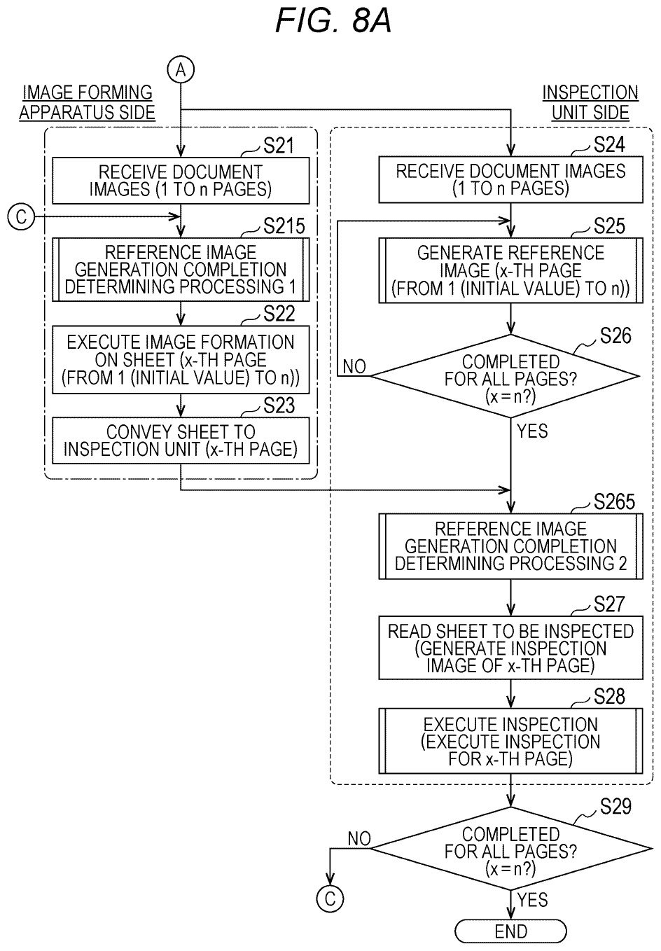

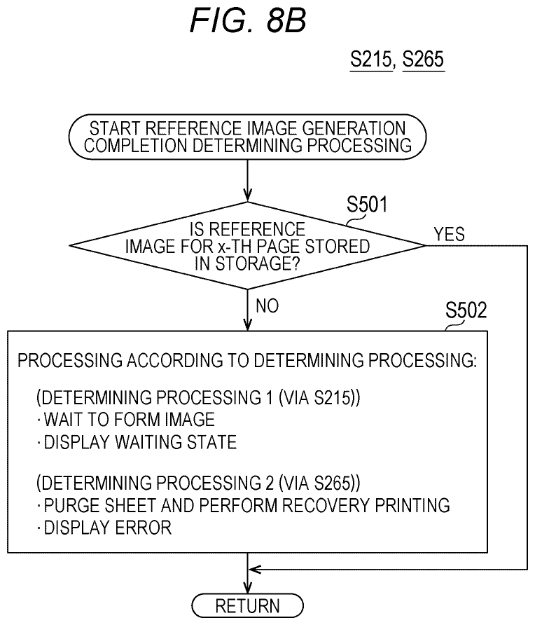

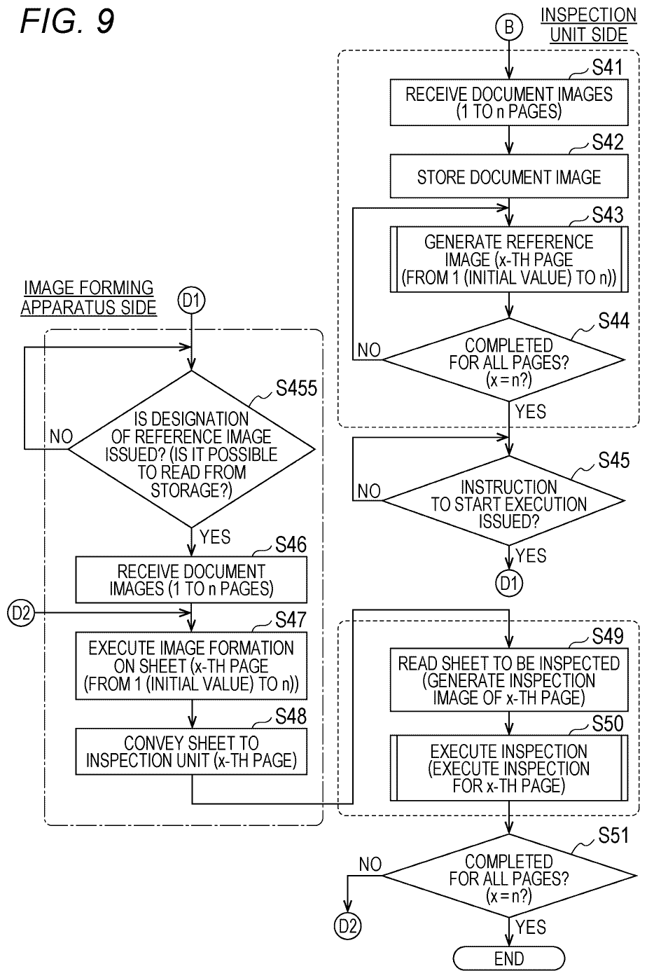

The controller 11 of the image inspection apparatus 100 determines the timing of generating the reference image received by the timing designation receiving section 115. When the designation received by the timing designation receiving section 115 from the user indicates the first inspection mode and the second timing as the timing of generating the reference image, the processing proceeds to FIG. 8 (indicated by encircled “A” in FIG. 7). On the other hand, when the designation received by the timing designation receiving section 115 from the user indicates the second inspection mode and the first timing, the processing proceeds to FIG. 9 (indicated by encircled “B” in FIG. 7). The execution instruction to execute inspection having the designation of the second timing is the one received by the operation screen s1 in FIG. 6A as described above and indicates the first inspection mode. The execution instruction to execute inspection having the designation of the first timing is the one received by the operation screens s3 and s4 in FIGS. 6C and FIG. 6D or the operation screen s6 and s7 in FIGS. 6F and FIG. 6G as described above and indicates the second inspection mode.

FIG. 8A is referred to. In FIG. 8A (and also in FIG. 9), processing enclosed by a dash-dot line on the left side is performed on the image forming apparatus 10 side, and processing enclosed by a dashed line on the right side is performed on the inspection unit 30 side. The processes of steps S21 to S23 on the image forming apparatus 10 side and the processes of steps S24 to S26 on the inspection unit side may be performed in parallel. That is, the image formation by the image former 16 and the generation of the reference image by the reference image generator 311 are performed at the same time. For example, in parallel with the formation of the inspection image based on the first page by the image former 16, the generation of the reference images for the third and fourth pages by the reference image generator 311 is performed as illustrated in FIG. 5. Further, the process of step S25 and the processes of steps S27 and S28 may be performed in parallel. For example, in step S25, the reference image generator 311 generates a reference image for the fifth page as illustrated in FIG. 5. Then, at the same time, the sheet to be inspected is read in step S27, and at the same time, the inspection image is inspected by the image inspector 312 in step S28.

### Step S21

The image former 16 of the image forming apparatus 10 receives the document images (1 to n).

### Step S215

The controller 31 performs reference image generation completion determining processing 1 (hereinafter, referred to as determining processing, determining processing 1, or the like) before the image inspection (step S28). FIG. 8B is a subroutine flowchart illustrating the determining processing. The determining processing here will be described later.

### Step S22

The image former 16 forms an image on the sheet based on the document image. x is a value incrementing to the n-th page from 1 that is the initial value. The image former 16 forms images on the sheets in order from the first to n-th pages. x indicates the current page value. Note that the controller 11 (or the controller 31) may cause the image former 16 to form images after generation of the reference images for all pages (pages 1 to n).

### Step S23

The image forming apparatus 10 forms an image on a sheet and conveys the sheet having the image formed thereon to the inspection unit 30.

### Step S24

The inspection unit 30 receives a document image. The controller 31 stores the received document image in the page memory or the storage 32.

### Step S25

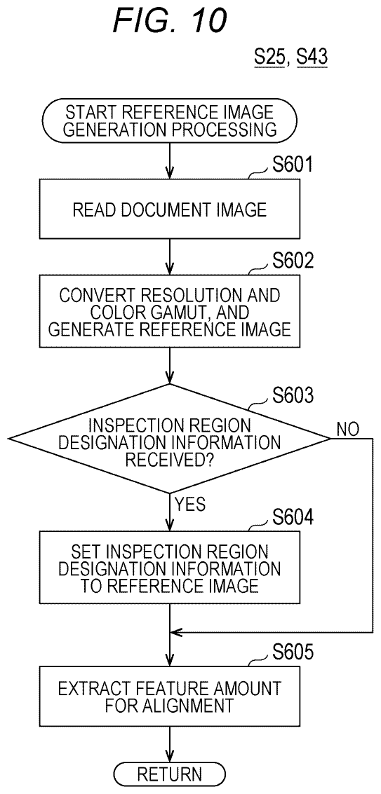

The reference image generator 311 generates a reference image based on the document image. FIG. 10 is a subroutine flowchart illustrating the processing of generating a reference image.

### Step S601

The reference image generator 311 reads the document image stored in the page memory or the storage 32.

### Step S602

The reference image generator 311 performs resolution conversion and color gamut conversion processing on the document image and obtains converted image data (temporary reference image). This image data serves as a reference image by performing the processes of the following steps S603 to S605.

### Step S603

If the inspection region designation information is received (YES), the reference image generator 311 advances the processing to step S603, and if not (NO), skips step S603. As described above, the inspection region designation information is not necessarily used in all the image inspections and may be omitted. The inspection region designation information is included in the inspection condition information. The inspection region designation information includes the designation of inspection regions, and the designation of inspection exclusion regions as described above.

### Step S604

The reference image generator 311 sets the inspection region designation information to the reference image.

### Step S605

The reference image generator 311 extracts a feature amount for alignment from the reference image. Examples of the feature amount for alignment include contour information and edge information of the image. Then, the processing of FIG. 10 is ended, and the processing returns to the original processing (RETURN). (Step S26)

FIG. 8 is again referred to. Here, when the processing for all pages has not been completed, the controller 31 increments x, and performs the process of step S25 on the next page. On the other hand, when the processing for all pages has been completed (YES), that is, when the generation of the reference images up to the n-th page (x=n) has been completed, the processing proceeds to the next step S265. As described above, the process of step S25 may be performed in parallel with the processes of steps S27 and S28.

### Step S265

Here, the controller 31 performs determining processing 2 before the image inspection (step S28).

### Step S501

The controller 31 determines whether or not the reference image for the x-th page is stored in the storage 32. When the reference image for the x-th page has been generated in the storage 32 and is stored in the storage 32 (YES), the controller 31 ends the processing of FIG. 8B and returns to the processing of FIG. 8A. When the determining processing 1 in step S215 is performed, the controller 31 executes the processes of step S22 and subsequent steps, and when the determining processing 2 in step S265 is performed, the controller 31 executes the processes of step S27 and subsequent steps. On the other hand, when the reference image is not stored in the storage 32, the controller 31 advances the processing to step S502. Such a situation occurs because the generation of the reference image may not be in time. This is for the following reasons. The time for generating the reference image varies depending on the contents of the document image and an amount of inspection region designation information. Therefore, the time for generating the reference image may be longer than the time for image formation. As another example, it may be determined as the determination in step S501 whether or not the reference image for the x-th page has already been generated and prepared.

### Step S502

The controller 31 and the main body controller 11 perform processing in accordance with the determining processing.

When the determining processing 1 has been performed, the main body controller 11 causes the image forming apparatus 10 to wait to perform image formation regarding the x-th page. For example, the image forming apparatus 10 delays the timing of feeding the sheet or stops the sheet with a registration roller in the image former 16 for some extra time. Further, information indicating that a waiting state is generated due to waiting is displayed on the operation panel 17 or the like.

When the determining processing 2 has been performed, the image of the x-th page for which the image inspection cannot be performed has already been formed on the sheet or is being formed, and thus, the controller 31 determines the sheet of the x-th page as a waste sheet. The controller 11 performs the purge process on the x-th page to eject the sheet to the purge tray by the purge device 40. Furthermore, the controller 11 executes recovery printing on the x-th page. In addition, the controller 11 displays an error display indicating that waste sheet is generated on the operation panel 17 or the like.

### Step S27

The image reader 33 of the inspection unit 30 reads the sheet to be inspected (x-th page) conveyed from the image forming apparatus 10 and generates a read image. The read image is used as an inspection image.

### Step S28

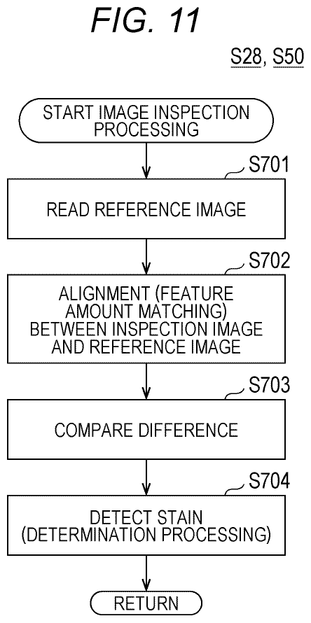

The image inspector 312 inspects the inspection image of the x-th page read and generated in step S27. FIG. 11 is a subroutine flowchart illustrating the image inspection processing.

### Step S701

The image inspector 312 reads the reference image for the x-th page stored in the storage 32 or the page memory.

### Step S702

The image inspector 312 aligns the reference image for the x-th page with the inspection image of the same x-th page generated in step S27. The alignment is performed by associating (matching) the feature amount of the reference image extracted in step S604 with the feature amount of the inspection image. The image inspector 312 aligns two images by coordinate transformation or coordinate shift by associating the feature amounts with each other.

### Steps S703 and S704

The image inspector 312 calculates a difference between corresponding pixel values of the reference image and the inspection image after alignment and determines the quality of the inspection image according to the magnitude of the difference. Thus, the processing of FIG. 11 is ended, and the processing returns to the original processing (RETURN).

### Step S29

FIG. 8 is again referred to. Here, when the processing for all pages has not been completed, the image inspection apparatus 100 increments x, and performs the processes of step S22 and the subsequent steps on the next page. On the other hand, when the processing for all pages has been completed (YES), that is, when the inspection up to the n-th page (x=n) has been completed, the processing ends (END). The above is the image inspection processing in the first inspection mode. Next, the second inspection mode will be described with reference to FIG. 9.

### Second Inspection Mode

FIG. 9 is a flowchart illustrating the second inspection mode performed subsequently to FIG. 7. The second inspection mode illustrated in FIG. 9 will be described assuming that the designation of the first timing and an execution instruction to execute image inspection under that condition has been received with reference to FIGS. 6C to FIG. 6E. That is, in FIG. 9 described below, a reference image is newly registered, and thereafter, image inspection using the newly registered reference image is performed.

### Steps S41 and S42

The inspection unit 30 receives a document image. The controller 31 stores the received document image in the storage 32.

### Steps S43 and S44

The reference image generator 311 generates a reference image based on the document image. The processes of steps S43 and S44 are the same as those of steps S25 and S26, and the reference image is generated according to the subroutine flowchart illustrated in FIG. 10. When the generation of the reference image is completed, the timing designation receiving section 115 displays the operation screen s4 as illustrated in FIG. 6D.

### Step S45

When the instruction to start execution of the image inspection is issued (YES), the timing designation receiving section 115 advances the processing to step S46. Here, the instruction to start execution refers to a case where the job start button b5 has been pressed by the user on the operation screen s4. This corresponds to receiving the designation of the first timing at which the reference image generator 311 generates the reference image prior to the image formation.

### Steps S46 to S51

The processes of conveying the sheet on which the image has been formed to the inspection unit 30 by the image forming apparatus 10 herein are the same as the processes of steps S21 to S23 in FIG. 8, and the description thereof will be omitted.

### Steps S49 and S50

The image inspection processing and the like by the inspection unit 30 in steps S49 and S50 are the same as those of steps S27 to S29 in FIG. 8, and the description thereof will not be repeated.

As described above, the image inspection apparatus according to the present embodiment includes a reference image generator that generates a reference image to be used for inspection of an image formed on a recording medium. The image inspection apparatus also includes an image inspector that inspects the image formed on the recording medium based on the reference image, and a reception section that receives designation of a generation timing of generating the reference image. The image inspection apparatus also includes a controller that controls generation of the reference image by the reference image generator on the basis of the received generation timing. Thus, the time required for the processing from the generation of the reference image to the image inspection can be shortened by designating the generation timing of generating the reference image. The time required for the processing from the generation of the reference image to the image inspection can be shortened particularly by designating the generation timing of generating the reference image as a timing during the image formation as the second timing.

The main configurations of the inspection unit 30 and the image inspection apparatus 100 including the inspection unit 30 have been described above for describing the features of the above embodiment, and the configurations of the inspection unit 30 and the image inspection apparatus 100 including the inspection unit 30 described above are not limited to the above-mentioned configurations, and can be modified in various manners within the scope of the claims. In addition, a configuration included in a general image forming apparatus is not excluded. The scope of the present invention should be interpreted by the appended claims.

### MODIFICATION EXAMPLE

The image inspection apparatus 100 may include a terminal device 80 including a display. The terminal device 80 is provided with the timing designation receiving section 115 and receives designation of the timing of forming the reference image and an instruction to execute inspection through the operation screens s1, s3, etc. displayed on the display.

In addition, the means and method for performing various kinds of processing in the inspection unit 30 and the image inspection apparatus 100 according to the above-described embodiment can be implemented by either a dedicated hardware circuit or a programmed computer. The program may be provided by, for example, a computer-readable recording medium such as a USB memory or a digital versatile disc (DVD)-ROM or may be provided online via a network such as the Internet. In this case, the program recorded on the computer-readable recording medium is commonly transferred to and stored in a storage such as a hard disk. In addition, the program may be provided as independent application software or may be incorporated into software of an apparatus as one function of the apparatus.

While the embodiment of the present invention has been described and illustrated in detail, the disclosed embodiment has been created for purposes of illustration and example only, and not limitation. The scope of the present invention is to be interpreted by the wording of the appended claims.

What is claimed is:

1. An image inspection apparatus comprising a hardware processor that, generates a reference image to be used for inspection of an image formed on a recording medium;
inspects the image formed on the recording medium based on the reference image; and
receives designation of a generation timing of generating the reference image.

2. The image inspection apparatus according to claim 1, further comprising a controller that controls generation of the reference image on the basis of the generation timing.

3. The image inspection apparatus according to claim 1, further comprising an image former that forms the image on the recording medium based on a document image, wherein
the generation timing includes a first timing before image formation by the image former and a second timing different from the first timing.

4. The image inspection apparatus according to claim 3, wherein the second timing includes a timing during image formation by the image former.

5. The image inspection apparatus according to claim 3, further comprising:
a controller that performs control so that the document image is transmitted to the hardware processor and the image former on the basis of the reception of designation of the second timing.

6. The image inspection apparatus according to claim 5, wherein the controller causes the hardware processor and the image former to perform, in parallel, the generation of the reference image and formation of the image on the recording medium.

7. The image inspection apparatus according to claim 3, further comprising a controller that controls generation of the reference image according to the generation timing, wherein,
when receiving designation of the second timing and performing inspection on a sheet on which an image has been formed based on the document image of an x-th page among 1 to n pages, the controller determines, prior to inspection of the x-th page, whether or not generation of the reference image for the x-th page is completed.

8. The image inspection apparatus according to claim 3, further comprising a controller that controls generation of the reference image according to the generation timing, wherein,
when receiving designation of the second timing and performing inspection on a sheet on which an image has been formed based on the document image of an x-th page among 1 to n pages, the controller determines, prior to inspection of the x-th page, whether or not the reference image for the x-th page has already been generated and storing the reference image into a storage has been completed.

9. The image inspection apparatus according to claim 3, further comprising a controller that controls generation of the reference image according to the generation timing, wherein,
when receiving designation of the first timing, the controller determines, prior to image formation by the image former, whether or not a registered reference image to be used for inspection has been designated.

10. An image inspection method comprising:
generating a reference image to be used for inspection of an image formed on a recording medium;
inspecting the image formed on the recording medium based on the reference image; and
receiving designation of a generation timing of generating the reference image.

11. A computer-readable recording medium storing an image inspection program for causing a computer to execute processing including:
generating a reference image to be used for inspection of an image formed on a recording medium;
inspecting the image formed on the recording medium based on the reference image; and
receiving designation of a generation timing of generating the reference image.
